(19) United States
(12) Patent Application Publication
(10) Pub. No.: US 2006/0032694 A1
(43) Pub. Date: Feb. 16, 2006

(54) Exhaust pipe of vehicle

(76) Inventors: Tomoyuki Fujita, Nagoya-shi (JP); Yasuhiro Isogawa, Owariasahi-shi (JP)

Correspondence Address: KENYON & KENYON, 1500 K STREET NW, SUITE 700, WASHINGTON, DC, 20005, US

(21) Appl. No.: 11/044,210

(22) Filed: Jan. 28, 2005

(30) Foreign Application Priority Data
Jan. 30, 2004 (JP) 2004-023601

(51) Int. Cl. B60K 13/04

(52) U.S. Cl. 180/309

(57) ABSTRACT

The exhaust pipe includes a front section, a rear section, and a midway section. The front section and the rear section extend along a fore-and-aft direction of the vehicle. The midway section is located between the front section and the rear section. The midway section extends in a lateral direction of the vehicle. Further, the midway section has at least one bent portion, which is bent to have a corner oriented forward or rearward of the vehicle. As a result, stress applied to the exhaust pipe is reduced.

### BACKGROUND OF THE INVENTION

The present invention relates to an exhaust pipe of a vehicle, and more particularly, to a technique for suppressing vibration of the exhaust pipe.

Typically, an exhaust pipe of an engine mounted on a vehicle is provided with a catalytic converter and a muffler to purify exhaust gas. The exhaust pipe is attached to a vehicle body with a mounting member. When vibration of the engine is transmitted to the exhaust pipe, load repeatedly applied to the exhaust pipe by the vibration decreases the durability and the reliability of the exhaust pipe. In addition, when the vibration of the exhaust pipe is transmitted to the vehicle body via the mounting member, undesirable noise is caused in the vehicle. To solve this problem, Japanese Laid-Open Utility Model Publication No. 61-074620 proposes an exhaust pipe equipped with a mechanism for blocking vibration, such as a ball joint and a flexible joint. The mechanism is located in the exhaust pipe and permits a section of the exhaust pipe upstream the mechanism and a section of the exhaust pipe downstream the mechanism to be displaced relative to each other when vibration of the engine is transmitted to the exhaust pipe. As a result, the mechanism prevents vibration from being transmitted from the upstream section to the downstream section.

However, since the conventional exhaust pipe is equipped with the mechanism for blocking vibration, an additional space is required and the cost is increased by adding the mechanism.

### SUMMARY OF THE INVENTION

Accordingly, it is an objective of the present invention to provide an exhaust pipe that decreases repetitive stress generated by vibration of an exhaust system in a suitable manner with a simple structure.

To achieve the foregoing and other objectives and in accordance with the purpose of the present invention, an exhaust pipe of a vehicle is provided. The exhaust pipe includes a front section, a rear section, and a midway section. The front section and the rear section extend along a fore-and-aft direction of the vehicle. The midway section is located between the front section and the rear section. The midway section extends in a lateral direction of the vehicle. Further, the midway section has at least one bent portion, which is bent to have a corner oriented forward or rearward of the vehicle.

The present invention provides another exhaust pipe of a vehicle. The exhaust pipe includes a front section, a rear section, and a midway section. The front section and the rear section extend along a fore-and-aft direction of the vehicle, and are displaced from each other in a lateral direction of the vehicle. The midway section extends between the front section and the rear section. An outside bent portion is provided between the midway section and the front section and between the midway section and the rear section. The midway section has at least one bent portion being bent to have a corner oriented forward or rearward of the vehicle between the outside bent portions.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view illustrating an exhaust pipe according to one embodiment of the present invention;

FIG. 2 is an enlarged partial plan view illustrating the exhaust pipe of FIG. 1; and

FIG. 3 is an enlarged partial side view illustrating the exhaust pipe of FIG. 1.

### DETAILED DESCRIPTION OF THE PREFERRED EMBODIMENTS

One embodiment of the present invention will now be described with reference to the drawings.

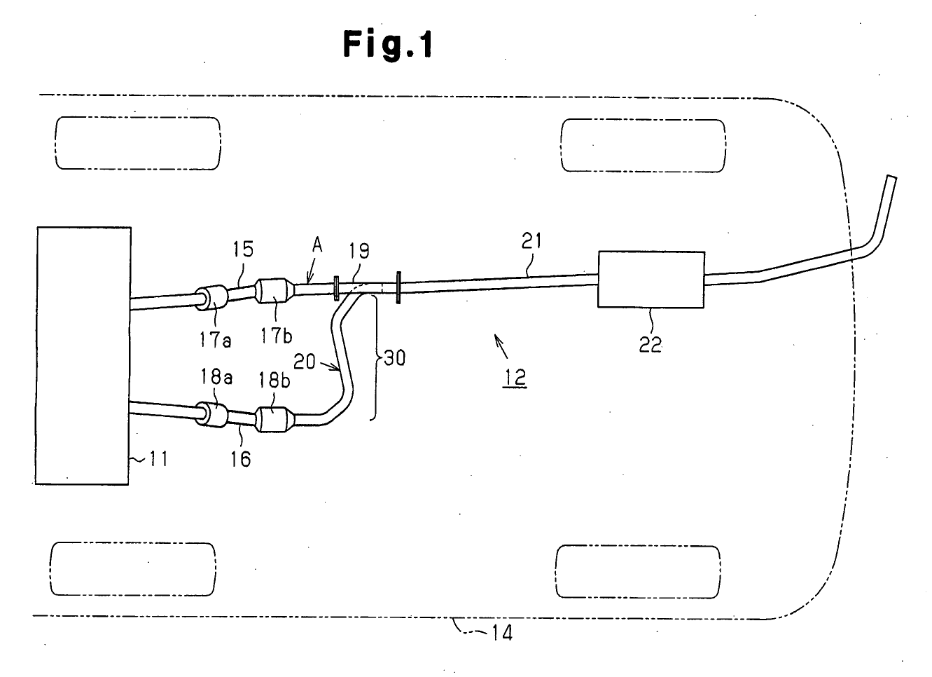

As shown in FIG. 1, an exhaust pipe 12 is connected to an engine 11 via an exhaust manifold, which is not shown. The exhaust pipe 12 is attached to a vehicle body with a mounting member, which is not shown, for absorbing vibration. The exhaust pipe 12 includes first and second front pipe members 15, 16, which extend along the fore-and-aft direction of a vehicle 14. The first and second front pipe members 15, 16 are substantially parallel to each other. Two catalytic converters 17a, 17b are connected in series at the middle of the first front pipe member 15, and two catalytic converters 18a, 18b are connected in series at the middle of the second front pipe member 16. The catalytic converters 17a, 17b, 18a, and 18b purify exhaust gas.

As shown in FIGS. 1 to 3, a rear pipe member 21 is connected to the first front pipe member 15 via a connecting pipe member 19. The rear pipe member 21 has a muffler 22 to reduce exhaust noise. The downstream end portion of the second front pipe member 16 is connected to the connecting pipe member 19 via a middle pipe member 20. The connecting pipe member 19 is bifurcated and has two inlets and one outlet. The first front pipe member 15 and the middle pipe member 20 are connected to the inlets of the connecting pipe member 19 and the rear pipe member 21 is connected to the outlet of the connecting pipe member 19. Therefore, exhaust from the engine 11 flows through the first and second front pipe members 15, 16 and merge at the connecting pipe member 19. The combined exhaust is then emitted through the rear pipe member 21.

Part of the middle pipe member 20 and part of the connecting pipe member 19 constitute a midway section 30 of the exhaust pipe 12. The midway section 30 corresponds to a portion of the exhaust pipe 12 that extends substantially along the lateral direction of the vehicle 14. More specifically, the midway section 30 corresponds to a portion from a bent portion (outside bent portion) 23 of the middle pipe member 20 to a bent portion (outside bent portion) 24 of the connecting pipe member 19. The midway section 30 permits the second front pipe member 16, which is the front section of the exhaust pipe 12, and the rear pipe member 21, which is the rear section of the exhaust pipe 12, to be displaced from each other in the lateral direction of the vehicle 14. On the other hand, the first front pipe member 15 is aligned with the rear pipe member 21.

A substantial part of the preferred embodiment will now be described.

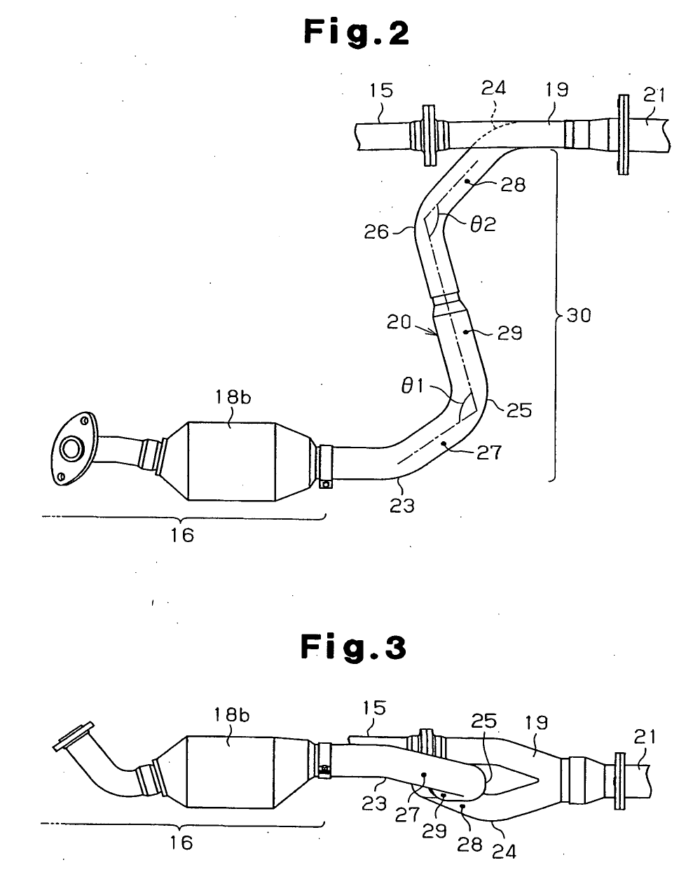

As shown in FIGS. 2 and 3, the midway section 30 has first and second bent portions 25, 26. The first bent portion 25 is formed on the middle pipe member 20, and the second bent portion 26 is formed on the connecting pipe member 19. The first and second bent portions 25, 26 are formed between the bent portions 23, 24. The first and second bent portions 25, 26 are provided such that the midway section 30 absorbs vibration. The first and second bent portions 25, 26 are bent to have corners oriented in different directions. In this embodiment, the first bent portion 25 located upstream with respect to the flow of exhaust is bent such that the corner is oriented rearward of the vehicle 14, and the second bent portion 26 located downstream with respect to the flow of exhaust is bent such that the corner is oriented forward of the vehicle 14. The positions of the first and second bent portions 25, 26 differ in the fore-and-aft direction of the vehicle 14. In this embodiment, the first bent portion 25 is located rearward of the vehicle 14 than the second bent portion 26. Since the midway section 30 has the first and second bent portions 25, 26, the midway section 30 is bent like a crank, in other words, bent in a zigzag as viewed from directly above.

Part of the midway section 30 between the first and second bent portions 25, 26 extends diagonally with respect to the lateral direction of the vehicle 14. More specifically, part of the midway section 30 between the first and second bent portions 25, 26 is inclined such that the part approaches the front side of the vehicle 14 toward the downstream end with respect to the flow of exhaust. The bending angle θ1 of the first bent portion 25 is the same as the bending angle θ2 of the second bent portion 26. In this embodiment, the bending angles θ1, θ2 of the first and second bent portions 25, 26 are both set to 130 degrees. The bending angles θ1, θ2 need not be an obtuse angle such as 130 degrees, but may be a right angle or an acute angle as long as the flow of exhaust is not hindered. The bending angle θ1 may also differ from the bending angle θ2.

The middle pipe member 20, in other words, the midway section 30 has a first inclined section 27, which is inclined downward from the upstream bent portion 23 to the first bent portion 25. The connecting pipe member 19, in other words, the midway section 30 has a second inclined section 28, which is inclined upward from the downstream bent portion 24 to the second bent portion 26. The midway section 30 has a horizontal section 29 formed between the inclined sections 27, 28. The first inclined section 27 and the second inclined section 28 are provided to further reduce the repetitive stress caused by vertical vibration applied to the middle pipe member 20.

This embodiment provides the following advantages.

The first and second bent portions 25, 26 formed in the midway section 30 of the exhaust pipe 12 permits the midway section 30 to absorb vibration. Therefore, vibration applied to the second front pipe member 16, or vibration applied to the connecting pipe member 19, is decreased by a simple structure. As a result, stress applied to a weak welded portion located at the middle of the first front pipe member 15 or the second front pipe member 16 is reduced.

The repetitive stress generated at the welded portion (a portion indicated by a letter A in FIG. 1) of the first front pipe member 15 was measured on the exhaust pipe 12 of the preferred embodiment equipped with the midway section 30 having the first and second bent portions 25, 26 and on an exhaust pipe of a comparative example equipped with a midway section without the bent portions 25, 26. The measurement result is shown in Table 1. As shown in Table 1, the repetitive stress generated by vibration transmitted in the vertical direction of the vehicle 14 was 25.19 MPa, and the repetitive stress generated by vibration transmitted in the lateral direction of the vehicle 14 was 27.17 MPa when the measurement was taken with the exhaust pipe of the comparative example.

In contrast, the repetitive stress generated by vibration transmitted in the vertical direction of the vehicle 14 was 18.47 MPa, and the repetitive stress generated by vibration transmitted in the lateral direction of the vehicle 14 was 21.29 MPa when the measurement was taken with the exhaust pipe 12 of the preferred embodiment. That is, the exhaust pipe 12 of the preferred embodiment equipped with the midway section 30 having the first and second bent portions 25, 26 reduced the repetitive stress in the vertical direction by 26.6% and the repetitive stress in the lateral direction by 21.6% as compared to the exhaust pipe of the comparative example. Therefore, the preferred embodiment suppresses deformation of the weak welded portion A (see FIG. 1).

| | Comparative | Preferred | |
|---|---|---|---|
| | Example | Embodiment | Stress |
| | (Without Taking | (After Taking | Reduction |
| | Countermeasure) | Countermeasure) | Rate |
| Stress in Vertical | 25.19 MPa | 18.47 MPa | 26.6% |
| Direction | | | |
| Stress in Lateral | 27.17 MPa | 21.29 MPa | 21.6% |
| Direction of Vehicle | | | |

Since the exhaust pipe 12 need not be provided with a mechanism for blocking vibration, such as a ball joint or a flexible joint, a space for arranging the mechanism is unnecessary. Therefore, the influence on peripheral parts is reduced when arranging the exhaust pipe 12. This adds to the flexibility of the design. If the peripheral parts are arranged at a position that interferes with the midway section 30, the bending angles θ1, θ2 of the bent portions 25, 26 are easily changed such that the midway section 30 does not contact the peripheral parts. Furthermore, since the exhaust pipe 12 need not be provided with the mechanism for blocking vibration, the structure of the exhaust pipe 12 is simplified, and the weight and the cost of the exhaust pipe 12 are reduced.

The first and second bent portions 25, 26 are formed in the midway section 30 and the corners of the bent portions 25, 26 are oriented in different directions. Therefore, the midway section 30 is bent in a zigzag. This increases the vibration absorbing efficiency of the midway section 30. In addition, the midway section 30 improves the reduction efficiency of the repetitive stress applied from several directions, such as the vertical direction and the lateral direction of the vehicle 14.

Since the exhaust pipe 12 has a simple structure of only forming the first and second bent portions 25, 26 in the midway section 30, noise is prevented from being generated as compared to the structure in which the mechanism for blocking vibration such as a ball joint is provided.

The above embodiment may be modified as follows.

In the preferred embodiment, two bent portions 25, 26 are formed in the midway section 30. However, the number of the bent portion may be one or more than two.

In the preferred embodiment, the portion between the first and second bent portions 25, 26 is straight, but may also be bent.

In the preferred embodiment, the corner of the upstream first bent portion 25 is oriented rearward of the vehicle 14 and the corner of the downstream second bent portion 26 is oriented forward of the vehicle 14. However, the direction in which each bent portion 25; 26 is oriented may be opposite to that shown in the illustrated embodiment. That is, the corner of the first bent portion 25 may be oriented forward of the vehicle 14 and the corner of the second bent portion 26 may be oriented rearward of the vehicle 14.

Therefore, the present examples and embodiments are to be considered as illustrative and not restrictive and the invention is not to be limited to the details given herein, but may be modified within the scope and equivalence of the appended claims.

1. An exhaust pipe of a vehicle, comprising:
a front section and a rear section, which extend along a fore-and-aft direction of the vehicle; and
a midway section located between the front section and the rear section, wherein the midway section extends in a lateral direction of the vehicle, the midway section having at least one bent portion, which is bent to have a corner oriented forward or rearward of the vehicle.

2. The exhaust pipe according to claim 1, wherein the bent portion is one of a plurality of bent portions provided in the midway section, the bent portions being bent to have corners oriented in different directions from each other.

3. The exhaust pipe according to claim 1, wherein the bent portion is one of at least two bent portions provided in the midway section, a portion of the midway section between the bent portions extends diagonally with respect to the lateral direction of the vehicle.

4. The exhaust pipe according to claim 3, wherein the portion of the midway section between the bent portions is inclined such that the portion approaches the front side of the vehicle toward the downstream end of the portion with respect to the flow of exhaust.

5. The exhaust pipe according to claim 3, wherein the portion of the midway section between the bent portions is inclined such that the portion approaches the front side of the vehicle from the front section toward the rear section.

6. The exhaust pipe according to claim 2, wherein the plurality of bent portions include at least a first bent portion and a second bent portion, a portion of the midway section between the first and second bent portions extends diagonally with respect to the lateral direction of the vehicle.

7. The exhaust pipe according to claim 1, wherein the bent portion is one of at least two bent portions provided in the midway section, the positions of the bent portions differ in the fore-and-aft direction of the vehicle.

8. The exhaust pipe according to claim 7, wherein one of the bent portions that is located close to the front section is located rearward of the vehicle than the bent portion located far from the front section.

9. The exhaust pipe according to claim 2, wherein the plurality of bent portions include at least a first bent portion and a second bent portion, the positions of the first and second bent portions differ in the fore-and-aft direction of the vehicle.

10. The exhaust pipe according to claim 2, wherein the midway section is bent in a zigzag.

11. The exhaust pipe according to claim 2, wherein the plurality of bent portions include at least a first bent portion and a second bent portion, the bending angles of the first and second bent portions are the same.

12. The exhaust pipe according to claim 1, wherein a portion of the midway section between the front section and the bent portion is inclined with respect to the horizontal.

13. The exhaust pipe according to claim 1, wherein a portion of the midway section between the rear section and the bent portion is inclined with respect to the horizontal.

14. The exhaust pipe according to claim 2, wherein the bent portions include at least a first bent portion and a second bent portion, which second bent portion being further from the front section than the first bent portion, and
wherein a portion of the midway section between the front section and the first bent portion is inclined downward from the front section toward the first bent portion, and a portion of the midway section between the rear section and the second bent portion is inclined upward from the rear section toward the second bent portion.

15. The exhaust pipe according to claim 14, wherein a portion of the midway section between the first bent portion and the second bent portion is horizontal.

16. The exhaust pipe according to claim 1, further comprising a pipe member connected to the rear section, wherein the pipe member extends in the fore-and-aft direction of the vehicle in front of the rear section.

17. An exhaust pipe of a vehicle, comprising:
a front section and a rear section, which extend along a fore-and-aft direction of the vehicle, wherein the front section and the rear section are displaced from each other in a lateral direction of the vehicle; and
a midway section, which extends between the front section and the rear section, an outside bent portion being provided between the midway section and the front section and between the midway section and the rear section, and the midway section has at least one bent portion being bent to have a corner oriented forward or rearward of the vehicle between the outside bent portions.

18. The exhaust pipe according to claim 17, wherein the bent portion is one of a plurality of bent portions provided in the midway section, the bent portions being bent to have corners oriented in different directions from each other.
